(19) United States
(12) Patent Application Publication
(10) Pub. No.: US 2012/0144952 A1
(43) Pub. Date: Jun. 14, 2012

(54) Outer tube of a steering shaft in a motor vehicle

(76) Inventors: Manfred Heintschel, Schwaebisch Gmuend (DE); Sebastian Kubisch, Durlangen (DE)

(21) Appl. No.: 12/931,789

(22) Filed: Feb. 10, 2011

Related U.S. Application Data
(63) Continuation of application No. PCT/EP2009/005275, filed on Jul. 21, 2009.

(30) Foreign Application Priority Data
Aug. 11, 2008 (DE) 10 2008 041 155.8

(51) Int. Cl. B62D 1/185

(52) U.S. Cl. 74/493

(57) ABSTRACT

An outer tube of a steering shaft in a motor vehicle, into which an inner shaft, which can be positively coupled in the direction of rotation, is telescopically insert able in the outer tube, has a wall thickness that varies in the circumferential direction, wherein radially recessed outside wall reduction sections having a reduced outside radius are provided on the outer casing.

This is a Continuation Application of PCT/EP2009/005275 filed Jul. 21, 2009.

### BACKGROUND OF THE INVENTION

The invention relates to an outer tube of a steering shaft in a motor vehicle.

DE 10 2005 028 054 B3 describes a telescoping steering shaft, which is composed of a telescoping inner steering column part and a telescoping outer steering column part, wherein the inner part and the outer part must be pushed together. The outer part forms an outer tube, the inner part is an inner shaft that is axially displaceably guided in the outer tube. So as to enable the transmission of steering torque, the outer tube and inner shaft are typically positively coupled in the circumferential direction, which is achieved, for example, by mutually engaging ball grooves and elevations on the inside of the outer tube and on the outside of the inner shaft. These ball grooves and elevations extending in the axial direction allow for the outer tube and inner shaft to be both telescopically pushed into, and pulled away from, each other.

In the design of the outer tube, care must be taken to ensure a low weight, yet high torque transmission. In addition, the outer tube should be easy to produce.

### SUMMARY OF THE INVENTION

It is the object of the invention to provide an outer tube of a steering shaft for a motor vehicle that is easy to produce and characterized by high torque transmission at a comparatively low weight.

The outer tube according to the invention is part of a steering shaft in a motor vehicle, with the steering shaft additionally comprising an inner shaft that is received in the outer tube, wherein the inner shaft and the outer tube can be telescopically displaced in relation to each other. In the direction of rotation, the outer tube and the inner shaft are positively coupled to each other so as to transmit a steering torque or torque. The positive engagement between the outer tube and the inner shaft located inside is achieved by radially mutually engaging ball grooves and elevations, which are configured on the outside of the inner shaft and on the inside of the outer tube. The ball grooves, for receiving balls, and the elevations cause a positive engagement in the circumferential direction, while the telescopic displaceability of the outer tube and inner shaft is not impaired in the axial or longitudinal direction by the form-fitting elements. The smooth translatory displaceability is decisively supported by the design of the ball bearing between the inner shaft and outer tube.

According to the invention, the outer tube has a varying wall thickness in the circumferential direction. Another characteristic of the outer tube is a circular envelope delimiting the outer casing, wherein radially recessed outside wall reduction sections are configured in segments on the outer casing, which have a reduced outside radius, in relation to the circular envelope. As viewed in the circumferential direction, these outside wall reduction sections adjoin circular segment-shaped ball groves on the inside of the outer tube, which represent the form-fitting elements. The outside wall reduction sections correspond to inside wall compensation sections configured at the same angular position, which are located on the inside of the outer tube and, as is analogous to the outside wall reduction sections, are likewise radially recessed.

This embodiment has numerous advantages. In particular, greater uniformity of the wall thickness of the outer tube is achieved, while transmitting maximum torque. In the central region between two ball grooves, distributed in the circumferential direction, the wall thickness of the outer tube is reduced on the inside wall and reinforced in the immediate vicinity of the ball groove. The reduced wall thickness results in significant weight reduction of the outer tube, without substantially lowering the rigidity or maximum torque transmission. Immediately adjacent to the ball grooves, the wall thickness of the outer tube, in contrast, is increased, whereby a comparatively strongly pronounced ball groove is achieved, for secure accommodation of the balls with good support in the circumferential direction. However, delimiting the wall thickness at this site, the outside wall reduction section having the reduced outside radius is provided on the outside, whereby the difference between the reduced wall thickness in the segment located between two ball grooves and in the immediate vicinity of each ball groove can be kept comparatively small. The circular segment shape of the ball grooves allows for planar guidance of the balls in the ball tracks under load.

The outer tube according to the invention takes all manufacturing engineering needs into consideration and constitutes an optimal solution with respect to the geometry. The almost round tube shape enables optimal torque transmission. Given the small differences in the wall thicknesses, the outer tube can be produced in one operation, whereby the high strain hardening required for the desired torque transmission is achieved. At the same time, sufficient core strength is obtained after heat treatment to prevent ball impressions under load. On the outside surface, the outer tube does not comprise any flutes; it rather has an approximately round and undulated shape, which has the advantage that, for welding, the outward heat-treated layer can be turned without the risk of severe weakening and the tube can also be automatically straightened during the manufacturing process.

The approximately round shape of the outer tube also allows for easy assembly by pushing the outer tube, for example, through the cab floor or the firewall of the vehicle using a round cab lead-through. In addition, the outer tube can be rotated directly in the cab lead-through.

The outer tube is optimized in terms of material use, and therefore has a low weight, despite maximum torque transmission. To improve the surface wear, it may be advantageous to heat treat the outer tube whereby, after high strain hardening, sufficient core strength is obtained to prevent ball impressions.

Radius changes both on the outside and on the inside of the outer tube are preferably done smoothly, for example by keeping the change in the outside radius and/or in the inside radius in the circumferential direction constant at least to the first derivative, and more preferably to the second derivative. The smooth radius transitions contribute to the prevention of stress peaks in the material of the outer tube.

The outer casing of the outer tube is advantageously radially recessed only in some segments, and more specifically in regions that immediately adjoin a ball groove on the inside wall of the outer tube in the circumferential direction. So as to prevent large differences in the wall thickness, the radius of the outer casing is reduced, for example, by no more than 10%, and more particularly by no more than 5%, in relation to the envelope in the region of the radially recessed outside wall reduction sections. Between the outside wall reduction sections and the regions between the two ball grooves, the wall thickness differs by no more than 25%, with any value up to 25% being possible. The radius of the inner casing between the inside wall compensation sections and the central regions, between two ball grooves, advantageously differs by no more than 20%, and more particularly by no more than 10%, and in this case any intermediate value up to the maximum limits should again be possible.

Further advantages and advantageous embodiments are disclosed in the remaining claims, the description of the figures, and the drawings.

### BRIEF DESCRIPTION OF THE DRAWINGS

FIG. 1 is a perspective view of a steering shaft, which is used in a motor vehicle, comprising an outer tube and an inner shaft that is received in the outer tube and can be telescopically displaced in the longitudinal direction, the shaft being positively coupled to the outer tube in the circumferential direction,

FIG. 2 is a sectional view of the outer tube,

FIG. 3 is a further sectional view of the outer tube in an enlarged illustration.

### DESCRIPTION OF THE PREFERRED EMBODIMENTS

In the figures, identical components are denoted by identical reference numerals.

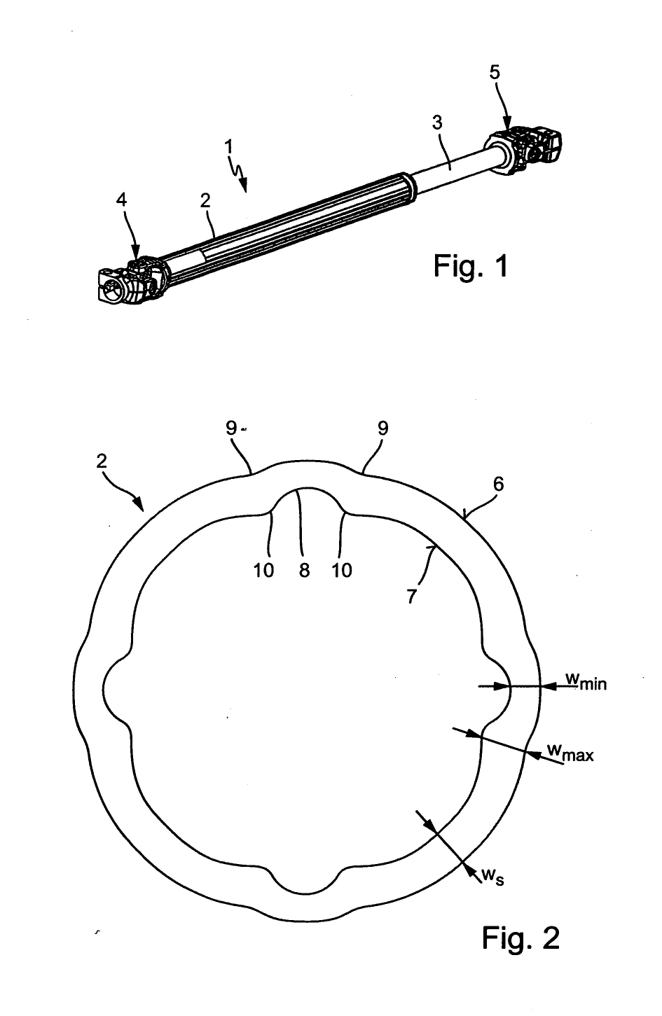

FIG. 1 shows a steering shaft 1 for installation in a motor vehicle, comprising an outer tube 2 and an inner shaft 3 received displaceably in the outer tube 2. The outer tube 2 and the inner shaft 3 are each provided with a welded-on joint 4 or 5 on opposing axial end faces. The inner shaft 3 is held displaceably in the outer tube 2 in an axially telescoping manner, however in the circumferential direction it is non-rotatably coupled to the outer tube 2 by means of form-fitting elements, so that only translatory relative axial displacement is possible between the outer tube 2 and inner shaft 3, but no relative rotational movement is possible. The form-fitting elements are designed as ball grooves or elevations on the inside of the outer tube or on the outer lateral surface of the inner shaft, which are configured to correspond to each other. Balls are guided in the ball grooves, thereby enabling a smooth relative displacement between the outer tube and inner shaft. The ball grooves and elevations extend in the longitudinal direction and thus allow relative axial displacement between the outer tube and inner shaft.

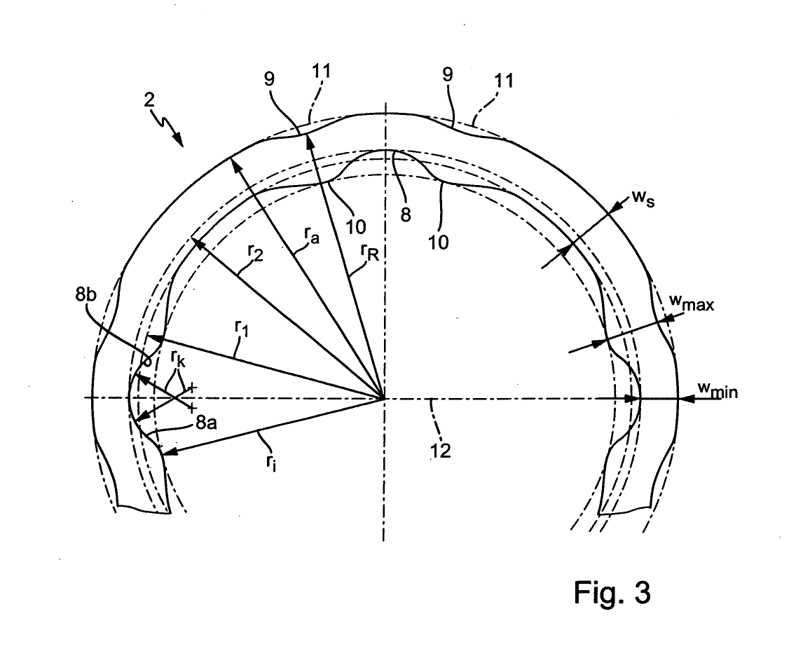

As is apparent from the sectional view of the outer tube 2 according to FIGS. 2 and 3, a total of four ball grooves 8 are provided on the inside 7 of the outer tube 2, distributed at 90° angles over the circumference, which constitute the form-fitting elements and match corresponding elevations on the outside of the inner shaft. The outer tube 2 has a minimal wall thickness wₘᵢₙ in the region of a ball groove 8. Immediately adjacent to the ball grooves 8, and more specifically on inside wall compensation sections 10 that immediately adjoin each ball groove 8 on either side in the circumferential direction, the wall thickness has a maximum value wₘₐₓ.

An outside wall reduction section 9 on the outside 6 corresponds to each inside wall compensation section 10 on the inside 7 of the outer tube 2. Compared in relation to an envelope 11 that is placed around the outer casing 6 (FIG. 3), the outside wall reduction section 9 has a slightly reduced radius r_{R}, while the envelope 11 has the maximum outside radius rₐ. The inside wall compensation section 10 has the minimal inside radius rᵢ; at this point, the wall thickness of the outer tube 2 has the maximum value wₘₐₓ. In the region of the minimal wall thickness wₘᵢₙ of the outer tube in the ball groove 8, the outer tube has a radius r₂; in the region located between two ball grooves 8, the wall thickness has the standard inside radius r₁. In this region located between two ball grooves 8, the wall thickness has the standard value wₛ.

The outside wall reduction sections 9, together with the corresponding inside wall compensation sections 10, cause the wall thickness to become more uniform. Compared to the standard wall thickness wₛ, the largest wall thickness wₘₐₓ is reached in the region of the outside wall reduction section 9 or inside wall compensation section 10, and the smallest wall thickness wₘᵢₙ is reached in the region of the ball grooves 8. The transition between the standard wall thickness wₛ first to the maximum wall thickness wₘₐₓ, and then to the minimal wall thickness wₘᵢₙ, in the circumferential direction, both on the outside of the outer tube, and on the inside, is continuous at least to the first derivative, and more preferably to the second derivative, whereby stress peaks in the material of the outer tube are prevented.

The outside wall reduction sections 9 have a radius r_{R}, which is only slightly smaller than the outside radius rₐ, wherein the deviation preferably does not exceed 5%. In this way, the outer casing 6 substantially coincides with the envelope 11, and the outer casing thus has an approximately circular shape.

As is further apparent from FIG. 3, the ball grooves 8 have a circular segment-shaped design and are each composed of two segments 8a and 8b, wherein each segment, taken by itself, has a circular segment-shaped design and has the radius rₖ. The two segments 8a, 8b have the same radius rₖ, wherein the radius center point of each segment, in relation to the midline 12 through the lowest point of the ball groove 8, is transversely offset. The radius center points are located on opposing sides of the midline 12, so that the radius vectors rₖ intersect each other. As a result, the circular segment-shaped sectors also intersect each other at the lowest point of the ball groove, which is also intersected by the midline 12. The lowest point of the ball groove 8 has the radius r₂.

Given this geometry of the ball groove 8, a ball that is guided in the ball groove, as viewed in the circumferential direction of the ball groove cross- section, has a contact point in the region of each segment 8a and 8b. Under load, the ball surface adapts linearly to the radius of each segment 8a or 8b. However, under load, the lowest point of the ball groove 8, in the region of the intersection point of the two segments, or in the region of the bisector with the segments, remains without contact; at this point, the ball surface has no contact with the ball groove, whereby the rolling of the balls in the ball grooves is improved.

### LIST OF REFERENCE NUMERALS

1 Steering shaft

2 Outer tube

3 Inner shaft

4 Joint

5 Joint

6 Outer casing

7 Inside

8 Ball groove

8a, 8b Segment

9 Outside wall reduction section

10 Inside wall compensation section

11 Envelope

12 Midline

1. An outer tube of a steering shaft in a motor vehicle, comprising an inner shaft to be guided in the outer tube, the inner shaft and the outer tube being telescopically displaceable in relation to each other and, in the direction of rotation, being positively couplable by four radially mutually engaging ball grooves and elevations on the inside of the outer tube and on the outside of the inner shaft, wherein:
the wall thickness of the outer tube varies in the circumferential direction;
the outer tube has a circular envelope delimiting the outer casing, wherein the circular envelope is seated at every point against the outside contour, over a total angle of at least 180°;
radially recessed outside wall reduction sections having a reduced outside radius are provided on the outer casing which, in the circumferential direction, adjoin circular segment-shaped ball grooves that are provided on the inside of the outer tube; and
radially recessed inside wall compensation sections are configured on the inside of the outer tube, corresponding to the radially recessed outside wall reduction sections, which are located on the outside.

2. The outer tube according to claim 1, wherein
the change in the inside radius in the transition to the inside wall compensation sections is constant at least to the first derivative.

3. The outer tube according to claim 2, wherein
the wall thickness in the region of the inside wall compensation sections is larger than the standard wall thickness of the outer tube outside of the inside wall compensation sections.

4. An outer tube according to claim 3, wherein
the wall thickness in the region of the ball grooves configured on the inside is smaller than the standard wall thickness of the outer tube.

5. An outer tube according to claim 4, wherein
the change of the outside radius in the transition to the outside wall reduction sections is constant at least to the first derivative.

6. An outer tube according to claim 5, wherein
the outside radius in the region of the radially recessed outside wall reduction sections is reduced by no more than 10%, and more particularly by no more than 5%, in relation to the envelope.

7. An outer tube according to claim 6, wherein
the inside radius in the region of the radially recessed inside wall compensation sections is reduced by no more than 20%, and more particularly by no more than 10%, in relation to the region between two ball grooves configured on the inside.

8. An outer tube according to claim 7, wherein
the wall thickness of the outer tube between the outside wall reduction sections and the regions outside of the outside wall reduction sections differs by no more than 25%.

9. An outer tube according to claim 8, wherein
the cross-section of the ball grooves comprises segments having the same radius, wherein the radius center point of each segment, in relation to a midline through the ball groove, is transversely offset.

10. The outer tube according to claim 9, wherein
the radius center points of the two segments are located on opposing sides of the midline.

11. An outer tube according to claim 1, wherein
the inside wall compensation sections are located on a circle having the radius rᵢ;
the regions outside of the ball grooves and inside wall compensation sections are located on a circle having the radius r₁,
the respective lowest point of the ball grooves is located on a circle having the radius r₂,
the outside wall reduction sections are located on a circle having the radius r_{R}, the circular envelope has the radius rₐ,
wherein the wall thickness wₘₐₓ is determined by (r_{R}−rᵢ)/2,
wherein the wall thickness wₘᵢₙ is determined by (rₐ−r₂)/2,
wherein the wall thickness wₛ is determined by (rₐ−r₁)/2, and
wherein wₘᵢₙ<wₛ<wₘₐₓ applies.

12. A steering column device in a motor vehicle, comprising an outer tube according to claim 11.

13. The outer tube according to claim 1, wherein the wall thickness in the region of the inside wall compensation sections is larger than the standard wall thickness of the outer tube outside of the inside wall compensation sections.

14. An outer tube according to claim 1, wherein the wall thickness in the region of the ball grooves configured on the inside is smaller than the standard wall thickness of the outer tube.

15. An outer tube according to claim 1, wherein the change of the outside radius in the transition to the outside wall reduction sections is constant at least to the first derivative.

16. An outer tube according to claim 1, wherein the outside radius in the region of the radially recessed outside wall reduction sections is reduced by no more than 10%, and more particularly by no more than 5%, in relation to the envelope.

17. An outer tube according to claim 1, wherein the inside radius in the region of the radially recessed inside wall compensation sections is reduced by no more than 20%, and more particularly by no more than 10%, in relation to the region between two ball grooves configured on the inside.

18. An outer tube according to claim 1, wherein the wall thickness of the outer tube between the outside wall reduction sections and the regions outside of the outside wall reduction sections differs by no more than 25%.

19. An outer tube according to claim 1, wherein the cross-section of the ball grooves comprises segments having the same radius, wherein the radius center point of each segment, in relation to a midline through the ball groove, is transversely offset.

20. A steering column device in a motor vehicle, comprising an outer tube according to claim 1.
